(19) United States
(12) Patent Application Publication
(10) Pub. No.: US 2025/0035775 A1
(43) Pub. Date: Jan. 30, 2025

(54) DIGITAL RADIO ALTIMETER VALIDATION SYSTEM

(71) Applicant: THALES, MEUDON (FR)

(72) Inventors: David CARSENAT, BRIVE LA GAILLARDE (FR); Benoît PORTEBOEUF, GENNEVILLIERS (FR); Nicolas ROUX, GENNEVILLIERS (FR)

(21) Appl. No.: 18/784,994

(22) Filed: Jul. 26, 2024

(30) Foreign Application Priority Data
Jul. 27, 2023 (FR) 2308110

(51) Int. Cl. G01S 13/88

(52) U.S. Cl. CPC G01S 13/882

(57) ABSTRACT

A digital radio altimeter validation system, provided with an input/output RF interface and characterized by an incompressible latency τ, configured to receive a linear chirp (FMCW) signal s(t) with linearly frequency-modulated continuous-wave f(t)=αt+β and with quadratic phase s(t)=e^{2jπ(αt}^{²}^{/2+βt+γ)}, that can also be written in complex form in cartesian coordinates I(t)+jQ(t), t representing the time, and configured to retransmit it according to a configurable delay and deliver to the radio altimeter a signal I′(t)+jQ′(t) that is exactly frequency-compensated for the latency τ by a linear extrapolation of its phase by calculation of difference between the current phase and the digitally delayed phase of the value to be compensated τ.

### CROSS-REFERENCE TO RELATED APPLICATION

This application claims priority to foreign French patent application No. FR 2308110, filed on Jul. 27, 2023, the disclosure of which is incorporated by reference in its entirety.

### FIELD OF THE INVENTION

The invention relates to a digital radio altimeter or radar altimeter validation RF card, with «Frequency-Modulated Continuous-Wave» or FMCW radar signals.

### BACKGROUND

A radio altimeter or radar altimeter is an instrument that makes it possible to measure the distance of an aircraft above the ground, by using the Radar principle.

Radio altimeter validation entails delaying the transmitted signal by highly varied orders of magnitude, from a few tens of us to a few tens of ms. Physical delay lines are bulky, expensive, and limited in the possible test scenarios that they offer.

Some digital systems do exist and offer greater flexibility, but remain fairly simplistic and do not make it possible to simulate very low heights for controlled slope radio altimeters.

The systems of the prior art do not make it possible to simulate both very low (close to 0 feet) and very high (close to 10,000 feet) heights flexibly and compatibly with the controlled slope radio altimeters.

### SUMMARY OF THE INVENTION

So, there is proposed, according to one aspect of the invention, a digital radio altimeter validation system, provided with an input/output RF interface and characterized by an incompressible latency τ, configured to receive a linear chirp (FMCW) signal s(t) with linearly frequency-modulated continuous-wave f(t)=αt+β and with quadratic phase s(t)=e^{2jπ(αt}^{²}^{/2+βt+γ)}, that can also be written in complex form in cartesian coordinates I(t)+jQ(t), t representing the time, and configured to retransmit it according to a configurable delay and deliver to the radio altimeter a signal I′(t)+jQ′(t) that is exactly frequency-compensated for the latency τ by a linear extrapolation of its phase by calculation of difference between the current phase and the digitally delayed phase of the value to be compensated τ, such that the frequency of this signal has no apparent delay.

This compensation makes it possible to simulate zero heights, and it can be extended to great heights by adding a digital delay corresponding to the associated propagation delay.

According to one embodiment, the digital radio altimeter validation system comprises:
a first converter configured to convert the signal transmitted in complex form in cartesian coordinates I(t−τ)+jQ(t−τ) into polar coordinates in the form ρe^{j(t-τ)};
a shifter configured to perform a left shift by one bit or binary multiplication by 2 of the phase of the output signal of the first converter;
a time delay unit configured to apply a delay of said latency τ to the phase of the output signal of the first converter;
a subtractor configured to subtract the output phase of the shifter from the output phase of the time delay unit; and
a second converter configured to convert the output signal of the digital system, having for its modulus ρ that at the output of the first converter and for its phase the output phase of the subtractor 2Φ(t−τ)−ϕ(t−2τ), into a signal in complex form in cartesian coordinates I′(t)+jQ′(t).

A linear chirp is a signal with linear modulation of frequency f, and therefore with quadratic phase ϕ, that can respectively be expressed in the form

$$f ( t ) = α t + β and ϕ ( t ) / 2 π = {\int }_{0}^{t} f ( u ) du + γ = \frac{α {t}^{2}}{2} + β t + γ .$$

The parameters α, β can be expressed as a function of the minimum fₘᵢₙ and maximum fₘₐₓ frequencies of the chip and of its duration T according to

$$α = \frac{{f}_{max} - {f}_{min}}{T} ,$$

β=fₘᵢₙ, and γ the initial fraction of the phase ϕ(0)/2π.

According to one embodiment, the first converter comprises a CORDIC module configured to implement a digital calculation by rotation of coordinates for calculations of trigonometrical and hyperbolic functions.

In one embodiment, the time delay unit comprises a FIFO queue.

According to one embodiment, the second converter comprises a CORDIC module configured to implement a digital calculation by rotation of coordinates for calculations of trigonometrical and hyperbolic functions.

In a variant, the second converter comprises a module for piecewise polynomial approximation of the complex exponential.

According to another embodiment, the digital radio altimeter validation RF card comprises:
a time delay unit (Ret2) configured to apply a delay of said latency τ to the signal received I(t), Q(t) from the radio altimeter by the RF card having already undergone an incompressible latency τ, I(t−τ), Q(t−τ), and deliver as output the signal received from the radio altimeter delayed by 2τ, I(t−2τ), Q(t−2τ);
a complex multiplier (MultComplexe) configured to apply complex multiplications to the signal received I(t), Q(t) from the radio altimeter by the RF card having already undergone an incompressible latency τ, I(t−τ), Q(t−τ), and deliver as output the signals I²(t−τ)−Q²(t−τ), 2I(t−τ)Q(t−τ), and I²(t−τ)+Q²(t−τ)=ρ²(t−τ);
a conjugate multiplier (MultConj) configured to apply complex multiplications to the output signals of the time delay unit (Ret2) and signals I²(t−τ)−Q²(t−τ) and 2I(t−τ) Q(t−τ) output from the complex multiplier (MultComp) to deliver as output the signals I₃=I₁I₂+Q₁Q₂ and Q₃=I₂Q₁−Q₂I₁; and
a divider (Div) configured to apply divisions to the output signal of the conjugate multiplier (MultConj) by the output I²(t−τ)+Q²(t−τ)=ρ²(t−τ) of the complex multiplier (MultComplexe), and deliver as output the signal Î (t)+jQ(t)=ρe^{j(2ϕ(t-τ)-ϕ(t-2τ))}.

### BRIEF DESCRIPTION OF THE DRAWINGS

The invention will be better understood on studying a few embodiments described as nonlimiting examples and illustrated by the attached drawings in which:

FIG. 1 schematically illustrates a digital radio altimeter validation RF card, according to an aspect of the invention; and

FIG. 2 schematically illustrates a digital radio altimeter validation RF card, according to another aspect of the invention.

### DETAILED DESCRIPTION

The present invention relates to a digital radio altimeter validation system, provided with an input/output RF interface and characterized by an incompressible latency τ, configured to receive a linear chirp FMCW signal s(t) with linearly frequency-modulated continuous-wave f(t)=αt+β and with quadratic phase s(t)=e^{2jπ(αt}^{²}^{/2+βt+γ)}, that can also be written in complex form as cartesian coordinates I(t)+jQ(t), t representing the time. The digital radio altimeter validation system is also configured to retransmit the signal s(t) according to a configurable delay and deliver to the radio altimeter a signal I′(t)+jQ′(t) that is exactly frequency-compensated for the latency τ by a linear extrapolation of its phase by calculation of difference between the current phase and the digitally delayed phase of the value to be compensated t.

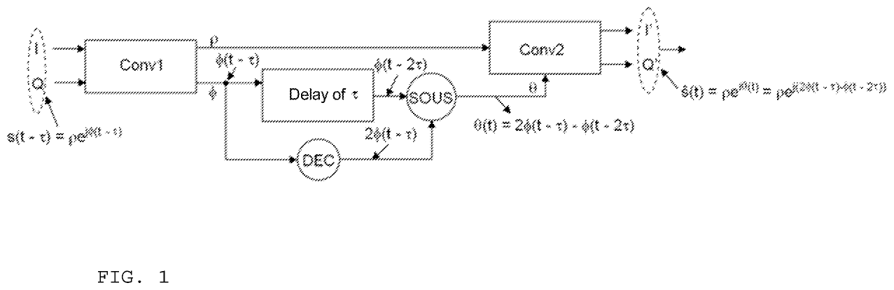

FIG. 1 schematically represents a digital radio altimeter validation RF card, according to an embodiment of the invention.

The digital system is also configured to deliver to the radio altimeter a corrected signal with a delay of 2τ in complex form in cartesian coordinates I′(t)+jQ′(t) corresponding to the signal reflected at a predetermined height, in which the received signal is compensated by a linear extrapolation of its phase, based on the current phase and on the digitally delayed phase of the value to be compensated τ.

The digital radio altimeter validation system comprises:
a first converter Conv1 configured to convert the signal transmitted in complex form in cartesian coordinates I(t−τ)+jQ(t−τ) into polar coordinates in the form ρe^{jϕ(t-τ)};
a shifter Dec configured to perform a left shift by one bit or binary multiplication by 2 of the phase of the output signal of the first converter Conv1;
a time delay unit Ret configured to apply a delay of said latency τ to the phase of the output signal of the first converter Conv1;
a subtractor Sous configured to subtract the output phase of the shifter Dec from the output phase of the time delay unit Ret; and
a second converter Conv2 configured to convert the output signal of the digital system, having for its modulus ρ that at the output of the first converter Conv1 and for its phase the output phase of the subtractor Sous 2ϕ(t−τ)−ϕ(t−2τ), into a signal in complex form in cartesian coordinates I′(t)+jQ′(t).

A digital system is proposed to be used to simulate the propagation channel, notably by introducing a delay using a FIFO queue to simulate a height. It is thus possible to perform all the desired tests.

Unfortunately, the RF interface at the input/output of the digital system has a latency τ that is incompressible by virtue of the propagation times, which prevents simulating heights less than hₘᵢₙ=cτ/2; c corresponding to the speed of propagation of the wave in its medium (generally comparable to the speed of light in a vacuum).

However, the fact of being in digital form makes it possible to compensate this delay by the application of a signal with negative (non-causal) phase slope. In other words, it is possible to use complex operators to compensate the phase of the quantity for which it has varied over the duration τ.

For example, the frequency-modulated continuous-wave received can be of the form e^{2jϕ(αt}^{²}^{/2+βt+γ)}, and the principle of the chirps can be linear with variable frequency slope f(t)=αt+β.

The phase correction is compatible with a zero propagation time for the testing of an FMCW radio altimeter.

It is possible to write the frequency of a linear chirp according to f(t)=αt+β, and therefore the associated chirp can be written s(t)=ρe^{2π(∫}^{₀}^{^{t}}^{d(u)du+γ)}=ρe^{2jπ(∫}^{₀}^{^{t}}^{αu+βdu+γ)}=ρe^{2jπ(αt}^{²}^{/2+βt+γ)}.

The received signal r then essentially corresponds to the transmitted signal s, with a delay t and an attenuation Λ. By mixing the two, a pure beat frequency is obtained:

$$BF ( t ) = s ( t ) \times {r}^{*} ( t ) = s ( t ) \times Λ {s}^{*} ( t - τ ) ;$$

$$BF ( t ) = {Λρ}^{2} \times {e}^{2 j π ( \frac{α {t}^{2}}{2} + β t + γ )} \times {e}^{- 2 j π ( \frac{{α ( t - τ )}^{2}}{2} + β ( t - τ ) + γ )} = {Λρ}^{2} \times {e}^{2 j π ( ατ t + τ ( β - ατ / 2 ) )}$$

The frequency of this signal is f_{BF}=ατ, and the height of the carrier can be deduced from this as

$$h = \frac{c \times τ}{2} = \frac{c \times {f}_{BF}}{2 α} .$$

It is possible to set the value of a on transmission and seek to determine the value of f_{BF} in reception, or to vary the value of a so as to obtain a frequency f_{BF} that is known. This latter principle, less complex to implement, is that of the controlled slope radio altimeters.

By studying the transmitted signal phase shifts, it appears that ϕ(t−τ)−ϕ(t−2τ)=τ(t)−ϕ(t−τ)−2πατ², i.e. ϕ(t)=2ϕ(t−τ)−ϕ(t−2τ)+2πατ². For a linear chirp, a is constant and therefore 2πατ² is also: by mixing the received signal delayed by t with the signal delayed by 2τ, a frequency-compensated signal is obtained.

The first converter Conv1 can comprise a CORDIC module configured to implement a digital calculation by rotation of coordinates for calculations of trigonometrical and hyperbolic functions.

The time delay unit Ret can comprise a queue of FIFO, first in first out, type.

The second converter Conv2 can comprise a CORDIC module configured to implement a digital calculation by rotation of coordinates for calculations of trigonometrical and hyperbolic functions.

In a variant, the second converter Conv2 can comprise a module for piecewise polynomial approximation of the complex exponential.

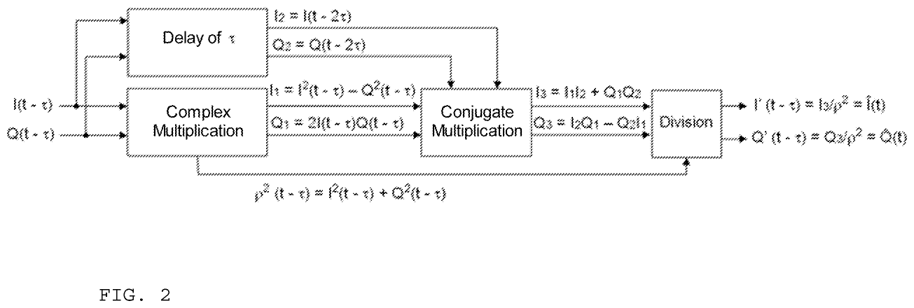

According to another embodiment, as illustrated in FIG. 2, the digital radio altimeter validation system comprises:
a time delay unit (Ret2) configured to apply a delay of said latency τ to the signal received I(t), Q(t) from the radio altimeter by the RF card having already undergone an incompressible latency τ, I(t−τ), Q(t−τ), and deliver as output the signal received from the radio altimeter delayed by 2τ, I(t−2τ), Q(t−2τ);
a complex multiplier (MultComplexe) configured to apply complex multiplications to the signal received I(t), Q(t) from the radio altimeter by the RF card having already undergone an incompressible latency τ, I(t−τ), Q(t−τ), and deliver as output the signals I²(t−τ)−Q²(t−τ), 2I(t−τ) Q(t−τ), and I²(t−τ)+Q²(t−τ)=ρ²;
a conjugate multiplier (MultConj) configured to apply complex multiplications to the output signals of the time delay unit (Ret2) and output signals I²(t−τ)−Q²(t−τ) and 2I(t−τ) Q(t−τ) of the complex multiplier (MultComp) to deliver as output the signals I₃=I₁I₂+Q₁Q₂ and Q₃=I₂Q₁−Q₂I₁; and
a divider (Div) configured to apply divisions to the output signals of the conjugate multiplier (MultConj) by the output I²(t−τ)+Q²(t−τ)=ρ² of the complex multiplier (MultComplexe), and deliver as output the signal Î (t)+j\hat{Q}(t)=ρe^{j(2ϕ(t-τ)-ϕ(t-2τ))}.

The fact of having a digital architecture makes it possible to perform complex dynamic scenarios with a wide variety of possible heights.

The phase compensation produced makes it possible to restore the value of the frequency.

The present invention is simple to implement, and insensitive to phase noise.

1. A digital radio altimeter validation system, provided with an input/output RF interface and characterized by an incompressible latency τ, configured to receive a linear chirp (FMCW) signal s(t) with linearly frequency-modulated continuous-wave f(t)=αt+β and with quadratic phase s(t)=e^{2jπ(αt}^{²}^{/2+βt+γ}), that can also be written in complex form in cartesian coordinates I(t)+jQ(t), t representing the time, and configured to retransmit it according to a configurable delay and deliver to the radio altimeter a signal I′(t)+jQ′(t) that is exactly frequency-compensated for the latency τ by a linear extrapolation of its phase by calculation of difference between the current phase and the digitally delayed phase of the value to be compensated t.

2. The digital radio altimeter validation system, according to claim 1, comprising:
a first converter (Conv1) configured to convert the signal transmitted in complex form in cartesian coordinates I(t)+jQ(t) into polar coordinates in the form ρe^{jΦ(t-τ)};
a shifter (Dec) configured to perform a left shift by one bit or binary multiplication by 2 of the phase of the output signal of the first converter (Conv1);
a time delay unit (Ret) configured to apply a delay of said latency τ to the phase of the output signal of the first converter (Conv1);
a subtractor (Sous) configured to subtract the output phase of the shifter (Dec) from the output phase of the time delay unit (Ret); and
a second converter (Conv2) configured to convert the output signal of the digital system, having for its modulus ρ that at the output of the first converter (Conv1) and for its phase the output phase of the subtractor (Sous) 2Φ(t−τ)−Φ(t−2τ), into a signal in complex form in cartesian coordinates I′(t)+jQ′(t).

3. The digital radio altimeter validation system, according to claim 2, wherein the first converter (Conv1) comprises a CORDIC module configured to implement a digital calculation by rotation of coordinates for calculations of trigonometrical and hyperbolic functions.

4. The digital radio altimeter validation system, according to claim 2, wherein the time delay unit (Ret) comprises a FIFO queue.

5. The digital radio altimeter validation system, according to claim 2, wherein the second converter (Conv2) comprises a CORDIC module configured to implement a digital calculation by rotation of coordinates for calculations of trigonometrical and hyperbolic functions.

6. The digital radio altimeter validation system, according to claim 2, wherein the second converter (Conv2) comprises a module for piecewise polynomial approximation of the exponential.

7. The digital radio altimeter validation system, according to claim 1, comprising:
a time delay unit (Ret2) configured to apply a delay of said latency τ to the signal received I(t), Q(t) from the radio altimeter by the RF card having already undergone an incompressible latency τ, I(t−τ), Q(t−τ), and deliver as output the signal received from the radio altimeter delayed by 2τ, I(t−2τ), Q(t−2τ);
a complex multiplier (MultComplexe) configured to apply complex multiplications to the signal received I(t), Q(t) from the radio altimeter by the RF card having already undergone an incompressible latency τ, I(t−τ), Q(t−τ), and deliver as output the signals I²(t−τ)−Q²(t−τ), 2I(t−τ)Q(t−τ), and I²(t−τ)+Q²(t−τ=ρ²(t−τ);
a conjugate multiplier (MultConj) configured to apply complex multiplications to the output signals of the time delay unit (Ret2) and output signals I²(t−τ)−Q²(t−τ) and 2I(t−τ)Q(t−τ) of the complex multiplier (MultComp) to deliver as output the signals I₃=I₁I₂+Q₁Q₂ and Q₃=I₂Q₁−Q₂I₁; and
a divider (Div) configured to apply divisions to the output signals of the conjugate multiplier (MultConj) by the output I²(t−τ)+Q²(t−τ)=ρ²(t−τ) of the complex multiplier (MultComplexe), and deliver as output the signal Î(t)+jQ(t)=ρe^{j(2ϕ(t-τ)-ϕ(t-2τ))}.
